(19) United States
(12) Patent Application Publication
(10) Pub. No.: US 2021/0252321 A1
(43) Pub. Date: Aug. 19, 2021

(54) FIRE SUPPRESSION SYSTEM AND METHOD OF USING THE SAME

(71) Applicant: Kidde Technologies, Inc., Wilson, NC (US)

(72) Inventors: Mark P. Fazzio, Wilson, NC (US); Harlan Hagge, Zebulon, NC (US); Adam Chattaway, Old Windsor (GB); Terry Simpson, Wake Forest, NC (US)

(21) Appl. No.: 16/791,179

(22) Filed: Feb. 14, 2020

(51) Int. Cl. A62C 37/08; A62C 3/08; A62C 35/02

(52) U.S. Cl. CPC A62C 37/08; A62C 99/0036; A62C 35/02; A62C 3/08

(57) ABSTRACT

Disclosed is a method of fire suppression, comprising: detecting with a sensor a fire stimulus in an environment surrounding the sensor; initiating a first discharge into the surrounding environment, wherein the first discharge comprises an inert gas, carbon dioxide, or any combination(s) thereof; and subsequent to initiating of the first discharge, initiating a second discharge into the surrounding environment, wherein the second discharge comprises a halocarbon.

### BACKGROUND

Exemplary embodiments pertain to the art of fire suppression systems, and more particularly, to halon 1301 alternative systems for fire suppression aboard aircraft and methods of using the same.

Many fire suppression systems use a suppressive agent known as halon 1301 (bromotrifluoromethane). However, halon 1301 has been found to have a depleting effect on the ozone layer in Earth's atmosphere. Accordingly, fire suppressing alternatives to halon 1301 are sought after in the art.

Many halon 1301 replacement agents which are deemed acceptable for land-based, total-flooding fire protection applications (e.g., computer rooms, machinery spaces, etc.), are not suitable for aircraft cargo compartments. For example, some vaporizing liquid agents such as hydrofluorocarbons are not capable of controlling deep-seated fire threats encountered in aircraft cargo compartments. In fact, the use of these agents below their inerting concentrations can actually increase the risk of certain fire hazards, for example, aerosol can explosions. The use of inert gases requires high extinguishing concentrations (e.g., greater than 40 volume percent) and therefore require large and impractical cylindrical containers. One particular halon 1301 alternative, known as trifluoroiodomethane, is considered thermally unstable and also fails to control deep-seated aircraft fire hazards.

Therefore, there is a need to develop an effective fire suppression system and method, which is an alternative to halon 1301 systems, for the protection of aircraft cargo compartments.

### BRIEF DESCRIPTION

Disclosed is a method of fire suppression, comprising: detecting with a sensor a fire stimulus in an environment surrounding the sensor; initiating a first discharge into the surrounding environment, wherein the first discharge comprises an inert gas, carbon dioxide, or any combination(s) thereof; and subsequent to initiating of the first discharge, initiating a second discharge into the surrounding environment, wherein the second discharge comprises a halocarbon.

Also disclosed is a fire suppression system, comprising: a sensor which detects a fire stimulus in an environment surrounding the sensor; a first container, from which a first discharge is initiated into the surrounding environment, wherein the first discharge comprises an inert gas, carbon dioxide, or any combination(s) thereof; and a second container, from which a second discharge is initiated, by a controller, into the surrounding environment, wherein the second discharge comprises a halocarbon, wherein initiation of the second discharge by the controller occurs subsequent to initiation of the first discharge.

### BRIEF DESCRIPTION OF THE DRAWINGS

The following descriptions should not be considered limiting in any way. With reference to the accompanying drawings, like elements are numbered alike:

FIG. 1 is a simplified diagram of a fire suppression system according to an exemplary embodiment;

FIG. 2 is a method flow chart for a method of fire suppression according to an exemplary embodiment.

### DETAILED DESCRIPTION

A detailed description of one or more embodiments of the disclosed pressure regulator and method are presented herein by way of exemplification and not limitation with reference to the Figures.

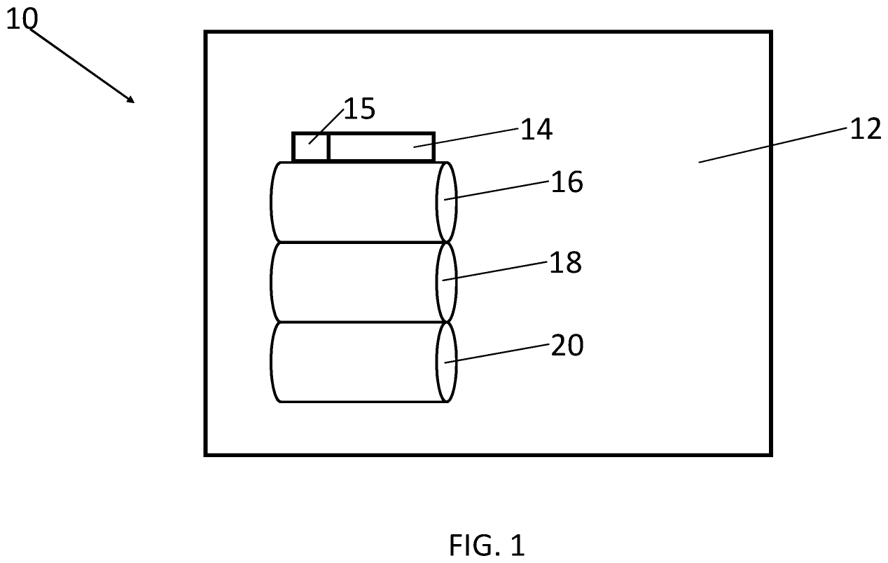

Referring to FIG. 1, a fire suppression system 10, according to one embodiment, can comprise a sensor 14 which detects a fire stimulus in a surrounding environment 12. The fire suppression system 10 can further comprise a first container 16, from which a first discharge can be initiated into the surrounding environment 12, wherein the first discharge comprises an inert gas, carbon dioxide, or any combination(s) thereof. The fire suppression system 10 can further comprise a second container, from which a second discharge can be initiated, by a controller 15, into the surrounding environment, wherein the second discharge comprises a halocarbon, wherein initiation of the second discharge by the controller 15 occurs subsequent to initiation of the first discharge.

According to an embodiment, the first container 16 and the second container 18 can be located adjacent to each other. According to an embodiment, the second container 18 can be located within the first container 16, or vice versa. According to an embodiment, a volume of the first container 16 can be less than or equal to 50 liters, for example, less than or equal to 30 liters, for example, less than or equal to 25 liters, for example, less than or equal to 20 liters. Not wishing to be bound by theory, the use of the second discharge reduces the need for inert gas in the first discharge. Accordingly, the present system 10 can be lighter in weight and smaller in volume as compared to fire suppression systems which rely mainly on inert gas. According to an embodiment, the fire suppression system 10 can further comprise a third container 20, from which a third discharge can be initiated into the surrounding environment 12, wherein the third discharge comprises a halocarbon.

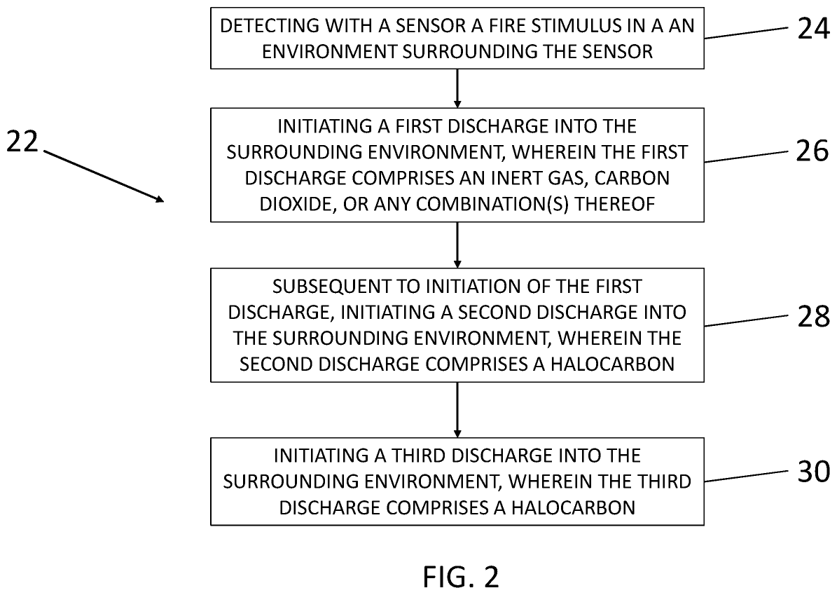

Referring to FIG. 2, a method of fire suppression 22 can comprise a step 24: detecting a fire stimulus in a surrounding environment. The method 22 can further comprise a step 26: initiating a first discharge into the surrounding environment, wherein the first discharge comprises an inert gas, carbon dioxide, or any combination(s) thereof. The method 22 can further comprise a step 28: initiating a second discharge into the surrounding environment, wherein the second discharge comprises a halocarbon, wherein initiation of the second discharge occurs subsequent to initiation of the first discharge.

According to an embodiment, the fire stimulus can comprise any physical or chemical byproducts of a fire hazard. For example, a temperature of greater than or equal to about 200° C., for example, greater than or equal to about 250° C., for example, greater than or equal to about 300° C., for example, greater than or equal to about 315° C., for example, greater than or equal to about 350° C., for example, greater than or equal to about 400° C., in the surrounding environment. The fire stimulus can comprise smoke, gas, or other chemical byproducts of a fire hazard, in the surrounding environment. According to an embodiment, the surrounding environment can comprise an interior of an aircraft, for example, a cargo compartment.

According to an embodiment, the first discharge can reduce a temperature of the surrounding environment to less than or equal to about 315° C., for example, less than or equal to about 300° C., prior to initiation of the second discharge. Not wishing to be bound by theory, the first discharge can displace hot air present in the surrounding environment (e.g., hot air created by a fire hazard). A reduction in environment temperature to less than or equal to about 315° C. allows for the use of a broader range of agents in the second discharge. For example, trifluoroiodomethane decomposes rapidly at temperatures above 315° C. (e.g., a half-life of about 2 to 3 minutes at about 340° C.), but the decomposition rate improves dramatically when temperature is reduced (e.g., a half-life of about 2 to 3 hours at about 315° C.). Accordingly, the temperature reducing first discharge of the present system can allow for the use of alternative suppressive agents such as trifluoroiodomethane.

The present systems and methods for fire suppression disclosed herein can also pass relevant safety regulation standards, for example, in accordance with the “Minimum Performance Standard for Aircraft Cargo Compartment Halon Replacement Fire Suppression Systems (2012 Update).” For example, the present systems and methods for fire suppression disclosed herein can pass tests related to deep-seated fire hazards as well as exploding aerosol can hazards.

According to an embodiment, the inert gas can comprise helium, neon, argon, krypton, xenon, radon, or any combination(s) thereof. According to an embodiment, the halocarbon can comprise iodide. According to an embodiment, the halocarbon can comprise an iodocarbon. An “iodocarbon” can refer to a chemical compound comprising iodine and carbon. According to an embodiment, the halocarbon comprises trifluoroiodomethane. According to an embodiment, the first discharge, the second discharge, or any combination(s) thereof does not comprise bromotrifluoromethane (halon 1301). According to an embodiment, the first discharge, the second discharge, or any combination(s) thereof can be in a gaseous state, a liquid state, a foam state, or any combination(s) thereof.

According to an embodiment, greater than or equal to about 95% of the first discharge by weight, for example, greater than or equal to about 99%, can be discharged in less than or equal to about 120 seconds, for example, less than or equal to about 60 seconds (i.e., “high-rate discharge”). According to an embodiment, greater than or equal to about 95% of the second discharge by weight, for example, greater than or equal to about 99%, can be discharged in less than or equal to about 120 seconds, for example, less than or equal to about 60 seconds (i.e., “high-rate discharge”). According to an embodiment, the second discharge can be discharged at a rate of about 0.2 kilograms to about 0.5 kilograms per minute, for example, about 0.4 kilograms to about 0.5 kilograms per minute, for example, about 0.45 kilograms per minute (i.e., “low-rate discharge”). According to an embodiment, a weight ratio of the first discharge to the second discharge can be about 1:1 to about 1:2. For example, the first discharge can comprise about 10 kilograms to about 12 kilograms of inert gas as compared to a second discharge comprising about 12 kilograms to about 24 kilograms of halocarbon.

According to an embodiment, the method of fire suppression 22 can further comprise step 30: initiating a third discharge into the surrounding environment, wherein the third discharge can comprise a halocarbon. According to an embodiment, the initiation of the third discharge can occur concurrent with, or subsequent to, initiation of the second discharge. According to an embodiment, the third discharge can be discharged at a rate of about 0.2 kilograms to about 0.5 kilograms per minute, for example, about 0.4 kilograms to about 0.5 kilograms per minute (i.e., “low-rate discharge”). According to an embodiment, the third discharge does not comprise bromotrifluoromethane.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of fire suppression, comprising:
detecting with a sensor a fire stimulus in an environment surrounding the sensor;
initiating a first discharge into the surrounding environment, wherein the first discharge comprises an inert gas, carbon dioxide, or any combination(s) thereof; and
subsequent to initiating of the first discharge, initiating a second discharge into the surrounding environment, wherein the second discharge comprises a halocarbon.

2. The method of claim 1, wherein the fire stimulus comprises a temperature of greater than about 200° C., smoke, or any combination(s) thereof, in the surrounding environment.

3. The method of claim 1, wherein the surrounding environment comprises an interior of an aircraft.

4. The method of claim 1, wherein the inert gas comprises helium, neon, argon, krypton, xenon, radon, or any combination(s) thereof.

5. The method of claim 1, wherein the halocarbon comprises an iodocarbon.

6. The method of claim 1, wherein the halocarbon comprises trifluoroiodomethane.

7. The method of claim 1, wherein the first discharge, the second discharge, or any combination(s) thereof are in a gaseous state, a liquid state, a foam state, or any combination(s) thereof.

8. The method of claim 1, wherein the first discharge reduces a temperature of the surrounding environment to less than or equal to about 315° C. prior to initiation of the second discharge.

9. The method of claim 1, wherein the first discharge, the second discharge, or any combination(s) thereof does not comprise bromotrifluoromethane.

10. The method of claim 1, wherein greater than or equal to about 95% of the first discharge by weight is discharged in less than or equal to about 120 seconds.

11. The method of claim 1, wherein greater than or equal to about 95% of the second discharge by weight is discharged in less than or equal to about 120 seconds.

12. The method of claim 1, wherein the second discharge is discharged at a rate of about 0.4 kilograms to about 0.5 kilograms per minute.

13. The method of claim 1, wherein a weight ratio of the first discharge to the second discharge is about 1:1 to about 1:2.

14. The method of claim 1, further comprising initiating a third discharge into the surrounding environment, wherein the third discharge comprises a halocarbon.

15. The method of claim 14, wherein the initiation of the third discharge occurs concurrent with, or subsequent to, initiation of the second discharge.

16. The method of claim 14, wherein the third discharge is discharged at a rate of about 0.2 kilograms to about 0.5 kilograms per minute.

17. A fire suppression system, comprising:
a sensor which detects a fire stimulus in an environment surrounding the sensor;
a first container, from which a first discharge is initiated into the surrounding environment, wherein the first discharge comprises an inert gas, carbon dioxide, or any combination(s) thereof; and
a second container, from which a second discharge is initiated, by a controller, into the surrounding environment, wherein the second discharge comprises a halocarbon, wherein initiation of the second discharge by the controller occurs subsequent to initiation of the first discharge.

18. The system of claim 17, wherein the first container and the second container are located adjacent to each other, or wherein the second container is located within the first container.

19. The system of claim 17, wherein a volume of the first container is less than or equal to 30 liters.

20. The system of claim 17, further comprising a third container, from which a third discharge is initiated into the surrounding environment, wherein the third discharge comprises a halocarbon.
